(19) United States
(12) Patent Application Publication
(10) Pub. No.: US 2022/0325726 A1
(43) Pub. Date: Oct. 13, 2022

(54) GAS PISTON ACCUMULATOR

(71) Applicant: AUDI AG, Ingolstadt (DE)

(72) Inventor: Roman RAUSCH, Krugzell (DE)

(73) Assignee: AUDI AG, Ingolstadt (DE)

(21) Appl. No.: 17/640,878

(22) PCT Filed: Jun. 17, 2020
(86) PCT No.: PCT/EP2020/066741

§ 371 Date: Mar. 7, 2022

(30) Foreign Application Priority Data
Sep. 17, 2019 (DE) 10 2019 124 968.6

(51) Int. Cl. F15B 1/24

(52) U.S. Cl. CPC F15B 1/24; F15B 2201/31; F15B 2201/205

(57) ABSTRACT

A gas piston accumulator with a piston-cylinder unit, the hydraulic space of which can be connected to a hydraulic line. A pressure piston biased with a biasing force acts on the hydraulic space in order to pressurize the hydraulic fluid in the hydraulic line with an accumulator pressure. The biasing force is achieved by a gas pressure in a gas space which is separated from the hydraulic space via the pressure piston, at least one cylinder base of the gas piston accumulator being assigned to the pressure piston as a mechanical stop, and the pressure piston having an axially set back piston main body, on the gas side of which and/or on the hydraulic side of which there protrudes a stop structure which is of reduced area compared to the respective pressure piston side and which can be brought into pressure contact with the cylinder base.

### FIELD

The invention relates to a gas piston accumulator.

### BACKGROUND

A generic gas piston accumulator is designed as a piston-cylinder unit, the hydraulic space of which is connectable to a hydraulic line. A pressure piston biased with a biasing force acts on the hydraulic space to apply an accumulator pressure to the hydraulic fluid in the hydraulic line. The biasing force is achieved by a gas pressure in a gas space, which is separated from the hydraulic space via the pressure piston. At least one cylinder base of the gas piston accumulator is assigned to the pressure piston as a mechanical stop. The pressure piston can be composed of an axially set back piston main body, on the gas side of which and/or on the hydraulic side of which protrudes a stop structure which is of reduced area compared to the respective pressure piston side and which can be brought into pressure contact with the cylinder base.

A separating device for fluid media is known from DE 10 2012 021 841 A1. A lightweight piston accumulator for vehicles is known from DE 10 2015 223 529 A1. A piston-cylinder unit is known from US 6 612 339 B1 or WO 2011/023747 A1. A piston accumulator is known from EP 704 331 B1.

### SUMMARY

The object of the invention is to provide a gas piston accumulator with a pressure piston, which can be realized as a lightweight element and which has an optimized mechanical stop structure.

In an exemplary application, the gas piston accumulator may no longer be of single-walled, but rather double-walled design, with an inner tube in which the pressure piston is axially guided, and with an outer tube that surrounds the inner tube at a distance, forming an annular gap. In this way, the inner tube primarily forms the piston running surface for the pressure piston. The outer tube, on the other hand, acts functionally independently of the inner tube, primarily as a load-bearing structure.

In a technical implementation, the pressure piston may divide the interior of the inner tube into the hydraulic space and the gas space. The annular gap between the inner and outer tubes is separated from the hydraulic space in a fluid- and pressure-tight manner. In contrast, the annular gap is in fluidic communication with the gas space. For example, at least one flow passage may be provided with which the gas space formed in the inner tube is fluidically connected to the annular gap.

In such a design, a filling method can be used which is applied in a similar form in the field of shock absorber manufacturing. Thus, the gas piston accumulator can first be completely assembled without pressure. The outer tube can then be tapped in a tapping step. The annular gap and the associated gas space can be evacuated through the taphole in the outer tube. Following this evacuation, the gas space can be filled with nitrogen. After nitrogen filling, the taphole can be sealed again by a spot weld or similar. Due to the double-walled nature of the gas piston accumulator, this type of filling is particularly suitable, since the outer tube no longer represents a functional surface (i.e., pressure piston running surface) and deformation of the outer tube by the tapping process step is no longer functionally relevant.

By means of the invention, a fast, simple as well as mass production filling process is thus made possible without providing a filling valve. In addition, the housing of the gas piston accumulator can be completely welded, such as a shock absorber. Sealing rings between housing parts can be omitted and the gas piston accumulator housing can be realized completely permeation-free. Furthermore, the pre-load pressure of the gas spring piston can be set precisely (due to low tolerances). In addition, a locking ring acting as a mechanical stop can be omitted.

In a further embodiment, the hydraulic space of the inner tube can be limited in the axial direction by a hydraulic-side cylinder base of the gas piston accumulator. In the hydraulic-side cylinder base, the mouth (oil inlet) of the hydraulic line is formed. In contrast, the gas space located in the inner tube can be bounded in the axial direction by a gas-side cylinder base of the gas piston accumulator. The gas-side cylinder base and the hydraulic-side cylinder base are arranged on the opposite gas piston accumulator end faces. Both cylinder bases (or at least one of them) can act as mechanical piston stops for the pressure piston. In addition, the two cylinder bases together with the outer tube may form an outer pressure piston accumulator housing in which the outer tube merges materially and/or integrally into the two axially opposite cylinder bases.

A dimensionally stable attachment of the inner tube in the gas piston accumulator is of great importance with regard to proper operability. With this in mind, a hydraulic-side tube end of the inner tube may be conically flared toward the hydraulic-side cylinder base to bridge the annular gap. The conically flared hydraulic-side tube end of the inner tube can be attached to the inner circumference of the outer tube and/or to the hydraulic-side cylinder base.

In addition, the inner tube can also be conically flared at its gas-side tube end, which allows the annular gap to be bridged. In this case, the gas-side tube end can also be attached to the inner circumference of the outer tube and/or to the gas-side cylinder base. The flow passage between the radial gap and the gas space may preferably be formed in the conically flared gas-side tube end of the inner tube.

The inner circumference of the inner tube may form the pressure piston running surface, while the outer tube may be functionally decoupled from the pressure piston. Preferably, the pressure piston running surface formed in the inner tube may be completely smooth and cylindrical. According to the invention, the cylinder bases of the gas piston accumulator act as mechanical stops for the pressure piston. When completely emptied, the pressure piston can be pressed in pressure contact against the hydraulic-side cylinder base by the biasing force generated in the gas space. If there is an excessively large pressure contact area between the pressure piston and the hydraulic-side cylinder base, there is the problem that the pressure piston tends to adhere to the hydraulic-side cylinder base due to a suction cup effect. This can lead to pressure peaks and/or pressure fluctuations in hydraulic operation. In this context, according to claim 1, the piston surface facing the hydraulic-side cylinder base is divided into an axially set back base surface from which a stop structure protrudes via an axial offset. Therefore, when completely emptied, the entire pressure piston surface cannot be in pressure contact over a large area with the hydraulic-side cylinder base, but only the stop structure with a smaller area.

It is particularly preferred if, when emptied, the stop structure of the pressure piston together with the hydraulic-side cylinder base and the inner tube delimit a filling chamber. When charging the gas pressure accumulator again, hydraulic fluid from the hydraulic line can initially flow into the filling chamber in order to help detach the pressure piston (adhering to the hydraulic-side cylinder base) from the hydraulic-side cylinder base.

As an alternative to an emptied state, the gas piston accumulator can be completely filled with hydraulic fluid after charging. When completely filled with hydraulic fluid, the pressure piston is pressed against the gas-side cylinder base against the biasing force until it is in pressure contact. f the contact surface between the pressure piston and the gas-side cylinder base is excessively large, there is also the problem that, due to a suction cup effect, the pressure piston initially remains stuck to the gas-side cylinder base even after the charging process has been completed (i.e., when starting a discharging process). In order to help detach the pressure piston from the gas-side cylinder base at the start of a discharging process, the pressure piston can be divided on its gas side into an axially set back base surface from which a stop structure protrudes via an axial offset.

When fully filled with hydraulic fluid (i.e., pressure piston is in pressure contact with the gas side cylinder base), the stop structure may define a filling chamber together with the gas side cylinder base and the inner tube. When starting the discharging process, gas can expand from the annular gap via the flow passage into the inner tube and flow into the gas-side filling chamber, thereby detaching the pressure piston from the gas-side cylinder base.

It is particularly preferred if the contact area of the pressure piston on the respective cylinder base is reduced to a minimum by a special piston geometry. Nevertheless, it must be ensured that the forces acting on the pressure piston are transmitted uniformly, so that the pressure piston itself is subjected to only a low deflection load. As an example, the piston material can be made of fiber composite plastic for a lightweight piston design.

With this in mind, the stop structure formed on the pressure piston according to the characterizing part of claim 1 has a sleeve-shaped extension protruding from the pressure piston base surface. The sleeve-shaped extension is arranged concentrically to the pressure piston circumference and/or coaxially to a gas piston accumulator longitudinal axis. The gas-side/hydraulic-side filling chamber in this case may extend continuously in the circumferential direction annularly around the sleeve-shaped extension. With regard to further equalizing the power transmission, it is preferred if the stop structure has additional radial webs which project from the outer circumference of the sleeve-shaped extension. The radially outer web sides thereof are arranged by a radial offset within the pressure piston circumference to ensure a filling chamber which is continuously open in the circumferential direction.

The sleeve-shaped projection of the stop structure of the pressure piston may define a blind hole-like recess radially inwardly. When completely emptied of hydraulic fluid or when completely filled with hydraulic fluid, the free annular end face of the sleeve-shaped extension of the pressure piston stop structure may be in pressure contact with the respective cylinder base. Therefore, when completely emptied of hydraulic fluid or when completely filled with hydraulic fluid, the blind hole-like recess is fluid-tightly decoupled from the filling chamber located radially outside the sleeve-shaped extension.

### BRIEF DESCRIPTION OF THE FIGURES

In the following, an embodiment of the invention is described with reference to the accompanying figures.

In detail:
FIG. 1 shows a sectional view of a gas piston accumulator;
FIG. 2 shows a sectional view of the gas piston accumulator in an operating position;
FIG. 3 shows a sectional view of the gas piston accumulator in an operating position;
FIG. 4 shows a view of the pressure piston;
FIG. 5 shows a view of the pressure piston;
FIG. 6 shows a view of the pressure piston;
FIG. 7 shows steps for filling the gas piston accumulator with gas; and
FIG. 8 shows steps for filling the gas piston accumulator with gas.

### DETAILED DESCRIPTION

FIG. 1 shows a gas piston accumulator which is formed as a piston-cylinder unit. In FIG. 1, the gas piston accumulator is double-walled with an inner tube 1 and an outer tube 3.

A pressure piston 5 is axially guided in the inner tube 1. The pressure piston 5 divides the tube interior of the inner tube 1 into a lower hydraulic space 7 and an upper gas space 9. The inner tube 1 is spaced from the outer tube 3 by a radial distance, forming an annular gap 13.

In FIG. 1, the gas space 9 located in the inner tube 1 is bounded upward in the axial direction by a gas-side cylinder base 15. Similarly, the hydraulic space 7 located in the inner tube 1 is bounded downward in the axial direction by a hydraulic-side cylinder base 17 in which a mouth (oil inlet) 19 of a hydraulic line 21 is formed. The two cylinder bases 15, 17 together with the outer tube 3 form an outer cylindrical gas piston accumulator housing 23.

As further shown in FIGS. 1, 2, and 3, a hydraulic-side tube end 25 of the inner tube 1 is conically expanded in the direction of the hydraulic-side cylinder base 17, whereby the annular gap 13 is bridged radially outward. The conically expanded, hydraulic-side tube end 25 is welded at the inner corner region between the outer tube 3 and the hydraulic-side cylinder base 17 by a pressure-resistant and fluid-tight welded joint.

Similarly, a gas-side, upper tube end 27 is conically expanded in the direction of the gas-side cylinder base 15, thereby bridging the annular gap 13 radially outward. In FIG. 1 or 3, the conically expanded gas-side tube end 27 is attached to the inner corner area between the outer tube 3 and the gas-side cylinder base 15. In this way, the overall result is a dimensionally stable double-wall structure in which less material is required compared to a single-wall structure.

The inner circumference of the inner tube 1 acting as a pressure piston running surface is completely smooth cylindrical between the two tube ends 25, 27.

FIG. 3 shows the gas piston accumulator in completely oil-empty state after an discharging process. Accordingly, the pressure piston 5 is pressed in pressure contact against the hydraulic-side cylinder base 17 by a biasing force Fᵥ generated by a gas pressure p_{gas} as in the gas space 9. If there is an excessively large contact area between the pressure piston 5 and the hydraulic-side cylinder base 17, an adhesive connection (due to a suction cup effect) may occur between the pressure piston 5 and the hydraulic-side cylinder base 17 when a charging process is started. In order to help detach the pressure piston 5 from the hydraulic-side cylinder base 17 at the start of the charging process, the pressure piston 5 has a small-area stop structure 29, which protrudes from an axially set back piston main body 31 by an axial offset Aa (FIG. 1). When completely emptied according to FIG. 3, the pressure piston 5 is therefore supported on the hydraulic-side cylinder base 17 via its small-area stop structure 29. FIG. 3 further shows that, in oil-empty state, a hydraulic filling chamber 33 is defined between the piston main body 31, the stop structure 29, the inner tube inner circumference and the hydraulic-side cylinder base 17. Thus, when the charging process is started, hydraulic fluid from the hydraulic line 21 first flows into the filling chamber 33 to assist in detaching the pressure piston 5 from the hydraulic-side cylinder base 17.

In FIG. 2, the gas piston accumulator is completely filled with hydraulic fluid after a successful charging process. Accordingly, in FIG. 2, the pressure piston 5 is brought into pressure contact with the gas-side cylinder base 15 against the biasing force Fᵥ. On its gas side, the pressure piston 5 also has a stop structure 29 (FIG. 1) protruding by an axial offset Δa from the piston main body 31. In FIG. 2, the stop structure 29 defines a gas-side filling chamber 35 together with the inner tube inner circumference, the piston main body 31 as well as the gas-side cylinder base 15. When starting a discharging process, the gas expands and flows from the annular gap 13 via the flow passage 10 into the inner tube 1 and further into the gas-side filling chamber 35 in order to help detach the pressure piston 5 from the gas-side cylinder base 15. The pressure piston 5 therefore has a stop structure 29 which is of reduced area on both sides, i.e. both on its hydraulic side and on its gas side, which can be brought into contact with the associated cylinder base 15, 17.

According to FIG. 4, the pressure piston 5 has a circumferential piston ring seal 37 on its outer piston circumference to ensure smooth axial adjustment of the pressure piston 5 along the pressure piston running surface in the inner tube 1.

In FIG. 5, the stop structure 29 is shown on the gas side (i.e., bottom side) of the pressure piston 5. Accordingly, the stop structure 29 has a sleeve-shaped extension 39 protruding from the pressure piston main body 31 and positioned concentrically to the pressure piston circumference. The hydraulic-side filling chamber 33 extends continuously in an annular shape around the sleeve-shaped extension 39 of the pressure piston 5. Radial webs 41 project from the outer circumference of the sleeve-shaped extension 39 in a star shape and are uniformly distributed circumferentially, the radially outer web sides of which are arranged with a radial offset Δr (FIG. 5) within the pressure piston circumference.

In FIG. 6, the pressure piston 5 is shown on its gas side (i.e., top side). Accordingly, the gas side stop structure 29 is of substantially the same construction as the hydraulic side stop structure 29 (FIG. 5). The sleeve-shaped extension 39 formed both on the gas side and on the hydraulic side of the pressure piston 5 delimits a blind hole-like recess 40 radially on the inside in FIG. 2 or 3. When completely emptied of hydraulic fluid (FIG. 3) or when completely filled with hydraulic fluid (FIG. 2), the free annular end face of the respective sleeve-shaped extension 39 of the pressure piston stop structure 29 is in pressure contact with the respective cylinder base 15, 17. Therefore, when completely emptied of hydraulic fluid or when completely filled with hydraulic fluid, the blind hole-like recess 40 in FIG. 2 or 3 is completely fluid-tightly decoupled from the filling chamber 33, 35 located radially outside the sleeve-shaped extension 39.

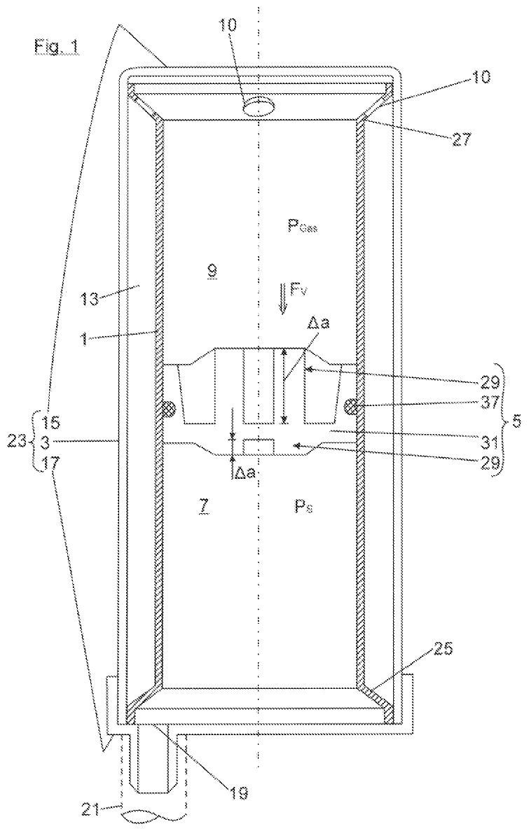

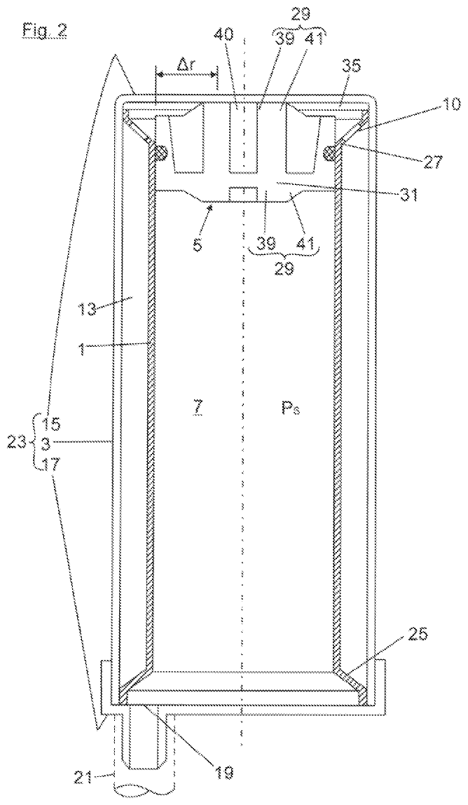

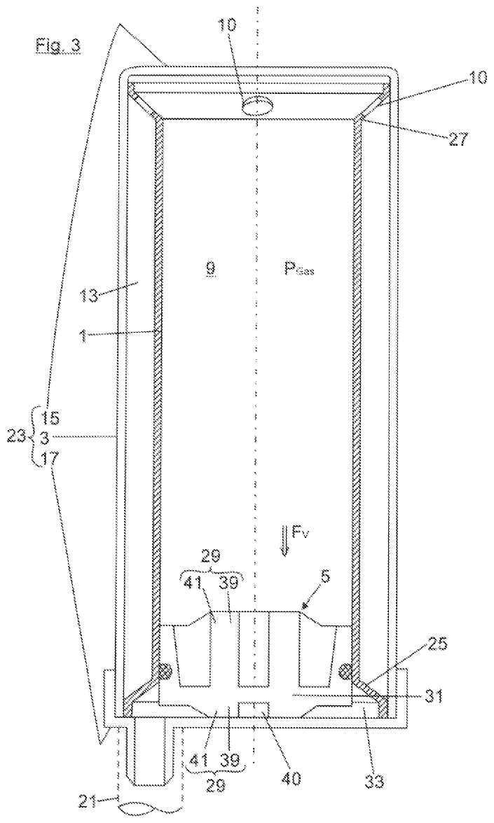

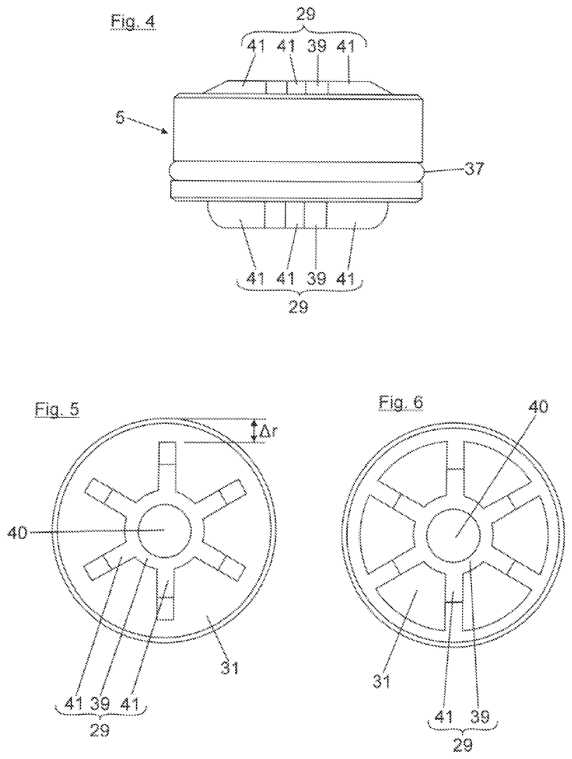

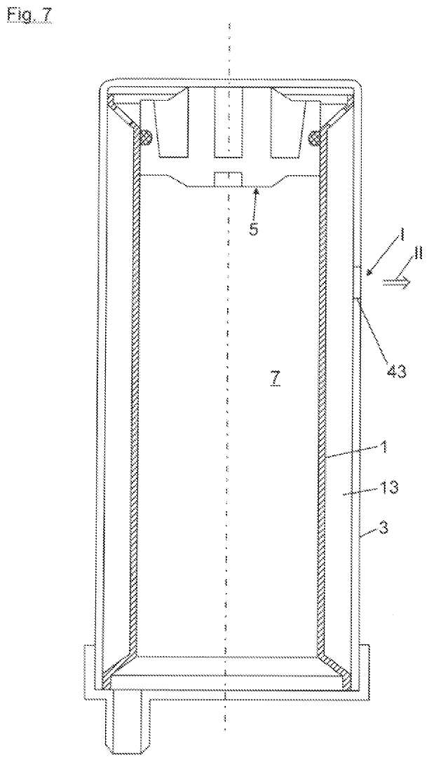

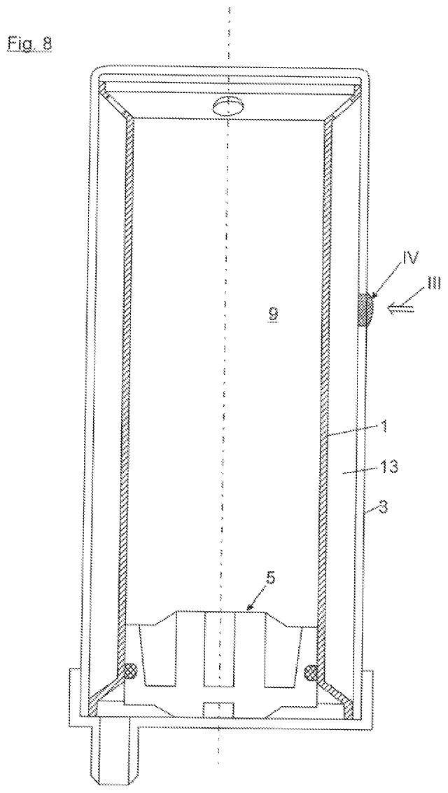

Steps for filling the gas piston accumulator with gas are illustrated in FIGS. 7 and 8. Accordingly, in a piercing step I, a filling opening 43 is pierced into the outer tube 3. This is followed by an evacuation step II, in which the interior of the gas piston accumulator is evacuated of air. After completion of the evacuation step II, a filling step III (FIG. 8) is performed, in which the annular gap 13 and the gas space 9 in the inner tube 1, which is fluidically connected thereto, are filled with gas, in particular nitrogen, via the filling opening 43 formed laterally on the outer tube 3. After the filling process, the filling opening 43 is sealed, for example welded shut, in a sealing step IV.

### REFERENCE NUMERALS

1 inner tube

3 outer tube

5 pressure piston

7 hydraulic space

9 gas space

13 annular gap

15 gas-side cylinder base

17 hydraulic-side cylinder base

19 oil inlet

21 hydraulic line

23 gas piston accumulator housing

25 hydraulic-side tube end

27 gas-side tube end

29 stop structure

31 piston main body

33 hydraulic-side filling chamber

35 gas-side filling chamber

37 piston ring seal

39 sleeve-shaped extension

40 blind hole-like recess

41 radial webs

Δa axial offset

Δr radial offset

p_{gas} pressure

pₛ accumulator pressure

Fᵥ biasing force

steps I to IV

1-10. (Canceled)

11. A gas piston accumulator comprising: a piston-cylinder unit, a hydraulic space of which can be connected to a hydraulic line, wherein a pressure piston pre-loaded with a biasing force acts on the hydraulic space in order to pressurize the hydraulic fluid in the hydraulic line with an accumulator pressure, wherein the biasing force is achieved by a gas pressure in a gas space which is separated from the hydraulic space via the pressure piston, wherein at least one cylinder base of the gas piston accumulator is associated with the pressure piston as a mechanical stop, and wherein the pressure piston has an axially set back piston main body, on the gas side of which and/or on the hydraulic side of which there protrudes a stop structure which is of reduced area compared to the respective pressure piston side and which can be brought into pressure contact with the cylinder base, wherein the stop structure formed on the pressure piston has a sleeve-shaped extension which protrudes from the piston main body and whose outer diameter is smaller than the circumferential diameter of the pressure piston and whose free annular end face can be brought into pressure contact with the cylinder base.

12. The gas piston accumulator of claim 11, wherein the sleeve-shaped extension of the pressure piston stop structure is arranged concentrically to the pressure piston circumference and/or coaxially to a gas piston accumulator longitudinal axis.

13. The gas piston accumulator of claim 11, wherein radial webs project from the outer circumference of the sleeve-shaped extension of the pressure piston stop structure, the radially outer web sides of which are spaced apart from the pressure piston circumference by a radial offset.

14. The gas piston accumulator of claim 11, wherein the sleeve-shaped extension of the pressure piston stop structure defines a radially inner blind hole-like recess , and, when completely emptied or completely filled with hydraulic fluid, the free annular end face of the stop structure is in pressure contact with the cylinder base and the blind hole-like recess is decoupled radially outwards in a fluid-tight manner

15. The gas piston accumulator of claim 11, wherein the gas piston accumulator is of double-walled design, namely with an inner tube, in which the pressure piston is axially guided, and with an outer tube, which surrounds the inner tube, forming an annular gap.

16. The gas piston accumulator of claim 15, wherein the pressure piston divides the tube interior of the inner tube into the hydraulic space and the gas space, and/or the annular gap is separated from the hydraulic space in a fluid-tight and pressure-tight manner and is fluidically connected to the gas space, and/or the gas space formed in the inner tube is connected to the annular gap via at least one flow passage.

17. The gas piston accumulator of claim 15, wherein the hydraulic space of the inner tube is bounded in the axial direction by a hydraulic-side cylinder base of the gas piston accumulator, and/or the gas space of the inner tube is bounded in the axial direction by a gas-side cylinder base of the gas piston accumulator, and/or the hydraulic-side cylinder base and/or the gas-side cylinder base act as mechanical piston stops for the pressure piston, and/or the outer tube merges materially and/or integrally into the two axially opposite cylinder bases, forming a gas piston accumulator housing.

18. The gas piston accumulator of claim 11, wherein, when emptied, the pressure piston together with the hydraulic-side cylinder base delimits a hydraulic-side filling chamber, and, during a charging process of the gas pressure accumulator, hydraulic fluid flows from the hydraulic line into the hydraulic-side filling chamber in order to assist a detachment of the pressure piston from the hydraulic-side cylinder base.

19. The gas piston accumulator of claim 11 wherein, when completely filled with hydraulic fluid, the pressure piston together with the gas-side cylinder base delimits a gas-side filling chamber, and, during a discharging process of the gas piston accumulator, the gas expands from the annular gap via the flow passage into the inner tube and further into the gas-side filling chamber and flows in, in order to help detach the pressure piston from the gas-side cylinder base.

20. The gas piston accumulator of claim 18, wherein the filling chamber extends continuously in the circumferential direction annularly around the sleeve-shaped extension of the pressure piston stop structure.

21. The gas piston accumulator of claim 12, wherein radial webs project from the outer circumference of the sleeve-shaped extension of the pressure piston stop structure, the radially outer web sides of which are spaced apart from the pressure piston circumference by a radial offset.

22. The gas piston accumulator of claim 12, wherein the sleeve-shaped extension of the pressure piston stop structure defines a radially inner blind hole-like recess, and, when completely emptied or completely filled with hydraulic fluid, the free annular end face of the stop structure is in pressure contact with the cylinder base and the blind hole-like recess is decoupled radially outwards in a fluid-tight manner

23. The gas piston accumulator of claim 13, wherein the sleeve-shaped extension of the pressure piston stop structure defines a radially inner blind hole-like recess, and, when completely emptied or completely filled with hydraulic fluid, the free annular end face of the stop structure is in pressure contact with the cylinder base and the blind hole-like recess is decoupled radially outwards in a fluid-tight manner

24. The gas piston accumulator of claim 12, wherein the gas piston accumulator is of double-walled design, namely with an inner tube, in which the pressure piston is axially guided, and with an outer tube, which surrounds the inner tube, forming an annular gap.

25. The gas piston accumulator of claim 13, wherein the gas piston accumulator is of double-walled design, namely with an inner tube, in which the pressure piston is axially guided, and with an outer tube, which surrounds the inner tube, forming an annular gap.

26. The gas piston accumulator of claim 14, wherein the gas piston accumulator is of double-walled design, namely with an inner tube, in which the pressure piston is axially guided, and with an outer tube, which surrounds the inner tube, forming an annular gap.

27. The gas piston accumulator of claim 16, wherein the hydraulic space of the inner tube is bounded in the axial direction by a hydraulic-side cylinder base of the gas piston accumulator, and/or the gas space of the inner tube is bounded in the axial direction by a gas-side cylinder base of the gas piston accumulator, and/or the hydraulic-side cylinder base and/or the gas-side cylinder base act as mechanical piston stops for the pressure piston, and/or the outer tube merges materially and/or integrally into the two axially opposite cylinder bases, forming a gas piston accumulator housing.

28. The gas piston accumulator of claim 12, wherein, when emptied, the pressure piston together with the hydraulic-side cylinder base delimits a hydraulic-side filling chamber, and, during a charging process of the gas pressure accumulator, hydraulic fluid flows from the hydraulic line into the hydraulic-side filling chamber in order to assist a detachment of the pressure piston from the hydraulic-side cylinder base.

29. The gas piston accumulator of claim 13, wherein, when emptied, the pressure piston together with the hydraulic-side cylinder base delimits a hydraulic-side filling chamber, and, during a charging process of the gas pressure accumulator, hydraulic fluid flows from the hydraulic line into the hydraulic-side filling chamber in order to assist a detachment of the pressure piston from the hydraulic-side cylinder base.

30. The gas piston accumulator of claim 14, wherein, when emptied, the pressure piston together with the hydraulic-side cylinder base delimits a hydraulic-side filling chamber, and, during a charging process of the gas pressure accumulator, hydraulic fluid flows from the hydraulic line into the hydraulic-side filling chamber in order to assist a detachment of the pressure piston from the hydraulic-side cylinder base.
